(19) United States
(12) Patent Application Publication
(10) Pub. No.: US 2008/0231776 A1
(43) Pub. Date: Sep. 25, 2008

(54) Backlight assembly and liquid crystal display having the same

(75) Inventors: Jin-soo Shin, Cheonan-si (KR); Tae-hyung Kim, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/077,495

(22) Filed: Mar. 18, 2008

(30) Foreign Application Priority Data
Mar. 22, 2007 (KR) 10-2007-0028207

(51) Int. Cl. G02F 1/13357; H05B 41/14

(52) U.S. Cl. 349/69; 349/61

(57) ABSTRACT

A backlight assembly is disclosed. The assembly includes a first substrate, a second substrate disposed adjacent to the first substrate and electrically connected to the first substrate, one or more light sources respectively disposed on the first and second substrates, a power-supply unit that is electrically connected to the first substrate and applies drive voltage to the light sources, and a bottom receiving container on the first substrate and the second substrate, in which the drive voltage is applied the first substrate, and is transmitted to the electrically connected second substrate through the first substrate.

### CROSS-REFERENCE TO RELATED APPLICATION

This application is based on and claims the benefit of priority of Korean Patent Application No. 10-2007-0028207 filed on Mar. 22, 2007, in the Korean Intellectual Property Office, the disclosure of which is incorporated herein in its entirety by reference.

### BACKGROUND OF THE INVENTION

1. Field of the Invention

The present invention relates to a backlight assembly and a liquid crystal display (LCD) having the same. More particularly, the present invention relates to a backlight assembly in which a backlight panel includes separately formed light-emitting diode (LED) bearing substrates electrically connected together, and an LCD having the same.

2. Description of the Related Art

Liquid crystal displays (LCD), which are perhaps the most widely used type of flat panel displays (FPD), are formed by placing two transparent substrates face to face and by inserting a liquid crystal layer between the two substrates. The LCD may also include a backlight assembly from which light is transmitted through liquid crystal layer. To display an image on an LCD, the amount of transmitted light is controlled by rearranging liquid crystal molecules of the liquid crystal layer by the application of voltages to the layer. The orientation of the liquid crystal molecules and the transmittance of light change in response to the direction and intensity of an applied electric field.

The backlight assembly includes a light source or multiple light sources. Some examples of light sources suitable for use in a backlight assembly include light-emitting diodes (LED), cold cathode fluorescent lamps (CCFL), and flat fluorescent lamps (FFL).

CCFLs have been mainly adopted for existing LCDs, but FFLs and LEDs are being increasingly used. LEDs are especially favored because they use little power and have a high luminance.

LEDs may be disposed in a regular array on a substrate to provide a backlight panel that radiates light from the lower side of the liquid crystal panel. As liquid crystal panels have become larger, the backlight panels have likewise become larger. The larger backlight panels have been divided into two or more substrates, and the substrates have been disposed on a plane so that together they form the backlight panel.

However, in the case where the backlight panel is divided into two or more substrates, a separate power supply unit is needed to control the drive voltage for each of the divided substrates.

Thus, there is a need for a backlight assembly in which a backlight panel that is divided into more than one substrate may be powered by a single power supply. Further, there is a need for an arrangement in which a power supply may be easily connected to more than one substrate in a backlight panel. In addition, there is a need to minimize the number of wires connected between substrates in a backlight panel in which one power supply supplies power to light sources on more than one substrate.

### SUMMARY OF THE INVENTION

The present invention provides a backlight assembly that includes a backlight panel including at least two separately formed substrates electrically connected together.

The present invention also provides a liquid-crystal display (LCD) apparatus including a backlight assembly having a backlight panel including separately formed substrates each having multiple LEDs, the substrates being electrically connected together.

The features of the present invention are not limited to the features described above. Other features and advantages of the present invention will be more definitely understood by those of ordinary skill in the art based on the following detailed description.

According to an exemplary embodiment of the present invention, there is provided a backlight assembly including a first substrate, a second substrate disposed adjacent to the first substrate, one or more first light sources disposed on the first substrate and one or more second light sources disposed on the second substrate, first wires provided on the first substrate, second wires provided on the second substrate, a connection member connecting the first wires to the second wires, a power-supply unit that is electrically connected to the first substrate, and that supplies power to the first light sources and to the second light sources, wherein the power supply unit is connected to the second light sources via the first wires, the connection member, and the second wires.

### BRIEF DESCRIPTION OF THE DRAWINGS

The above and other features and advantages of the present invention will become apparent from a detailed description of preferred embodiments thereof taken with reference to the attached drawings in which:

FIG. 1 is an exploded perspective view illustrating a liquid crystal display (LCD) according to a first embodiment of the present invention.

FIG. 2 is a perspective view illustrating the underside of a bottom receiving container included in the LCD of FIG. 1.

FIG. 3A is a perspective view illustrating the top side of a backlight panel included in the LCD of FIG. 1.

FIG. 3B is a perspective view illustrating the underside of the backlight panel of FIG. 3A.

FIG. 3C is a perspective view of a portion of the underside of the backlight panel of FIG. 3B.

FIG. 4A is a perspective view illustrating the underside of a backlight panel included in the LCD according to a second embodiment of the present invention.

FIG. 4B is a perspective view of a portion of the underside of the backlight panel of FIG. 4A.

FIG. 5A is a perspective view illustrating the underside of a backlight panel included in the LCD according to a third embodiment of the present invention.

FIG. 5B is a perspective view of a portion of the underside of the backlight panel of FIG. 5A.

FIG. 6A is a perspective view illustrating the underside of a backlight panel included in the LCD according to a fourth embodiment of the present invention.

FIG. 6B is a perspective view of a portion of the underside of the backlight panel of FIG. 6A.

FIG. 7A is a perspective view illustrating the underside of a backlight panel included in the LCD according to a fifth embodiment of the present invention.

FIG. 7B is a perspective view of a portion of the underside of the backlight panel of FIG. 7A.

FIG. 8 is a plan view illustrating the underside of a backlight panel according to the present invention;

FIG. 9 is a plan view of the underside of a backlight panel according to the present invention.

### DETAILED DESCRIPTION OF THE INVENTION

Various exemplary embodiments of the present invention will now be described more fully with reference to the accompanying drawings in which the exemplary embodiments are shown. In the drawings, the thicknesses of layers and regions may be exaggerated for clarity.

Detailed illustrative embodiments are disclosed herein. However, specific structural and functional details disclosed herein are merely representative for purposes of describing exemplary embodiments. This invention, however, may be embodied in many alternate forms and should not be construed as limited to only the exemplary embodiments set forth herein.

Accordingly, while the exemplary embodiments are capable of various modifications and alternative forms, these embodiments are shown by way of example in the drawings and will herein be described in detail. It should be understood, however, that there is no intent to limit the exemplary embodiments to the particular forms disclosed; the exemplary embodiments are to cover all modifications, equivalents, and alternatives falling within the scope of the invention. Like numbers refer to like elements throughout the description of the figures.

Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

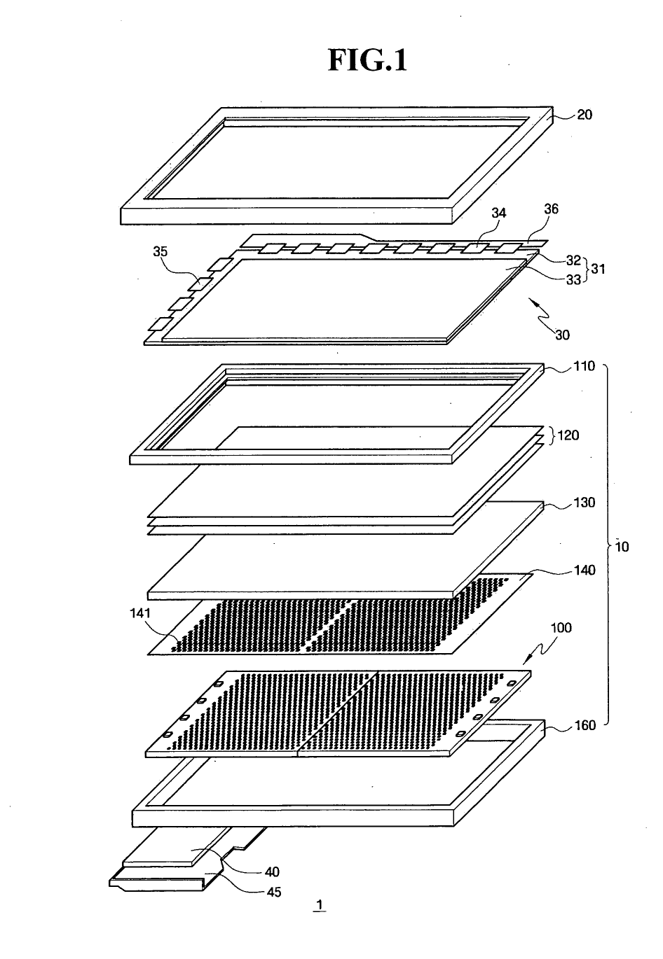

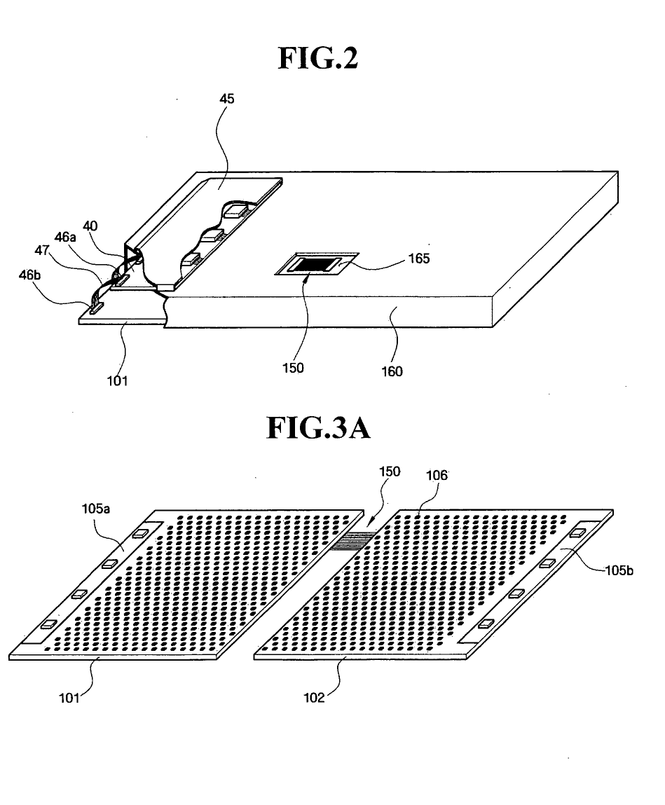

An LCD is described in detail with reference to FIGS. 1 to 3C. FIG. 1 is an exploded perspective view illustrating an LCD according to an exemplary embodiment of the present invention, and FIG. 2 is a perspective view illustrating the underside of a bottom receiving container included in the LCD of FIG. 1.

Referring to FIG. 1, an LCD 1 according to an embodiment of the present invention includes a liquid crystal panel assembly 30, an upper container 20, a backlight assembly 10, a power supply unit 40, and a cover 45.

The liquid crystal panel assembly 30 includes a liquid crystal panel 31 that includes a thin-film transistor substrate 32 and a common-electrode substrate 33, a gate driver 35 in a tape carrier package, a data driver in a tape carrier package, and a printed circuit board 36.

The thin-film transistor substrate 32 includes gate lines (not shown), a thin-film transistor array (not shown), and a pixel electrode array (not shown). The common-electrode substrate 33 includes a black matrix (not shown) and a common electrode (not shown), and is disposed opposite the thin-film transistor substrate 32. The liquid crystal panel 31 displays image information.

The upper container 20 provides the outward appearance of the LCD 1, and includes a space where the liquid crystal panel assembly 30 is contained. An open window is provided in the center of the upper container. The open window exposes the viewable area of the liquid crystal panel 31.

The upper container 20 is combined with the bottom receiving container 160, and a middle frame 110 is disposed between the upper container 20 and the bottom receiving container 160.

The backlight assembly 10 includes the middle frame 110, an optical sheet 120, a diffusion plate 130, a reflection sheet 140, a backlight panel 100, and the bottom receiving container 160.

The middle frame 110 receives the optical sheet 120, the diffusion plate 130, the reflection sheet 140, and the backlight panel 100, and is then attached to the bottom receiving container 160. The middle frame 110 includes side walls formed along the edges of a rectangle. An open window is provided in the center of the middle frame 110 so that light from the backlight panel 100, having passed through the diffusion plate 130 and the optical sheet 120, then passes thought the window in the middle frame 110.

The optical sheet 120 diffuses and concentrates the light transmitted from the diffusion plate 130. The optical sheet 120 is disposed on the upper side of the diffusion plate 130, and is received in the middle frame 110. The optical sheet 120 includes an upper prism sheet disposed above a lower prism sheet, and a protective sheet disposed on the upper prism sheet.

The upper and lower prism sheets refract the light after it has passed through the diffusion plate 130 and they concentrate the light at a low angle relative to the front side of the liquid crystal panel so that the brightness of the LCD is improved within a specified viewing angle. The protective sheet, disposed on the upper prism sheet, protects the surface of the upper prism sheet and diffuses the light to equalize the light distribution. The configuration of the optical sheet 120 is not limited to the above-described example, and the optical sheet can be implemented in various forms depending on the specification of the LCD 1.

The diffusion plate 130, which is disposed below the optical sheet 120, diffuses the light from each LED 106, so that a bright spot associated with each LED 106 point source is not displayed on the front side of the LCD 1. Other suitable light sources may be used in place of the LEDs 106.

The reflection sheet 140, disposed on the backlight panel 100, improves the efficiency of the backlight assembly by reflecting light towards the liquid crystal panel 31. Holes 141 are provided in the reflection sheet 140. When the reflection sheet 140 is positioned on the upper side of the backlight panel 100, the LEDs 106 are exposed through the holes 141, and the reflection sheet 140 reflects light toward the liquid crystal panel 31. A reflective surface is provided on the reflection sheet 140.

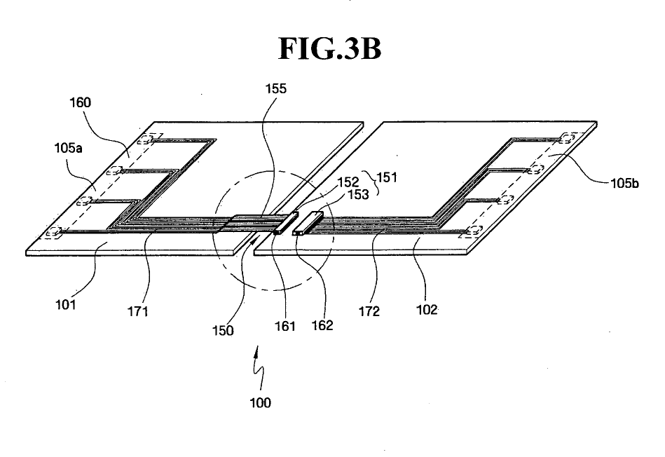

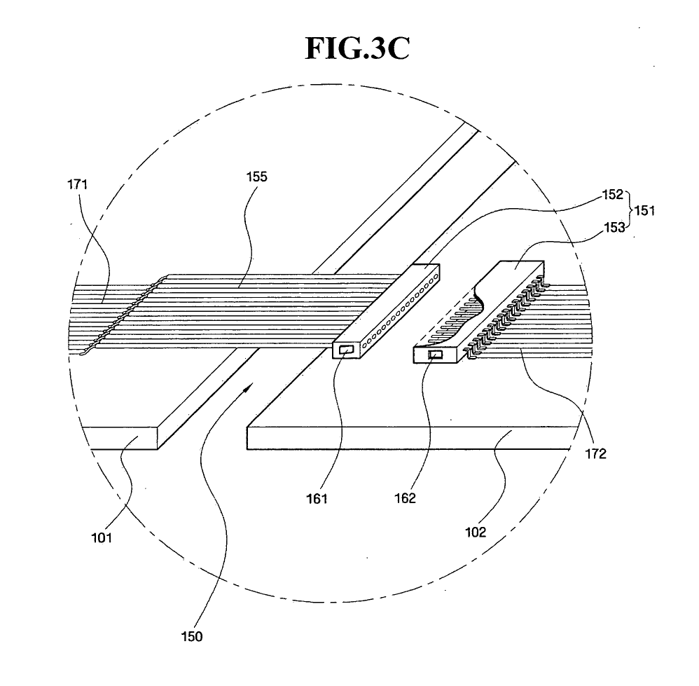

As shown in FIG. 3A, the backlight panel 100 includes a first substrate 101 and a second substrate 102 which are disposed side by side in a plane so as to form one larger substrate. The LEDs 106, which may be regarded as point sources, are disposed on the upper side of the first substrate 101 and on the upper side of the second substrate 102, and supply light to the liquid crystal panel 31. The backlight panel 100 will be described in more detail herein below.

The power-supply unit 40 coverts external power and provides power for the light sources. In the case where the LED 106 is used as the light source, for example, a DC/DC converter can be used as the power-supply unit 40.

The power-supply unit 40 may be disposed on the rear side of the bottom receiving container 160.

Further, after the power-supply unit 40 is disposed on the rear side of the bottom receiving container 160, the upper side of the power-supply unit 40 is covered by a cover 45 which allows the power-supply unit 40 to be protected from external impact. The cover 45 includes a radiative hole (not shown) so that heat, generated while the power-supply unit 40 is in operation, can be effectively discharged.

The power-supply unit 40 may be electrically connected to the first substrate 101 through the wires 47 connected to connectors 46A located on the power-supply unit 40 and connectors 46B located-on the first substrate 101. The voltage and signals, provided to the first substrate by the power-supply unit 40, are converted into a drive voltage by the auxiliary power-supply unit 105A located on the first substrate 101. The power supply unit 40 also supplies voltage and signals to the second auxiliary power supply unit 105B located on the second substrate 102 through the first wires 171 and the second wires 172 (described later).

The bottom receiving container 160 is disposed on the first substrate 101 and on the second substrate 102 at the lower side of the backlight panel 100, and includes an opening 165 so that a connection member 150 is exposed to the outside (described later). The connection member 150 is positioned at a location where the boundary between the first substrate 101 and the second substrate 102 of the backlight panel 100 is exposed. Thus, in the case where the backlight panel 100 is divided with the first substrate 101 on the left and the second substrate on the right as shown in FIG. 3A, the opening 165 is formed around the boundary in the backlight panel 100, and because various circuits for driving the LCD 1 are received at the center of the bottom receiving container 160, it is preferable that the opening 165 is formed, not at the middle of the bottom receiving container 160 but at the lower-middle side or upper-middle side, or in other words about midway between the center of the bottom receiving container 160 and an edge of the bottom receiving container 160, a shown in FIG. 2, or between the center of the bottom receiving container and the opposite edge of the bottom receiving container.

With reference to FIGS. 3A to 3C, the backlight panel 100 according to the first embodiment of the present invention is described. FIG. 3A is a perspective view of the upper side of the backlight panel 100 included in the LCD of FIG. 1. FIG. 3B is a perspective view of the lower side of the backlight panel of FIG. 3A, and FIG. 3C is a perspective view of a portion of the lower side of the backlight panel of FIG. 3B.

The backlight panel 100 is divided into the first substrate 101 and the second substrate 102, The LEDs 106 are disposed on the upper side of the first substrate 101 and the upper side of the second substrate 102 so that light is supplied to the liquid crystal panel 31. The LEDS 106 on the first panel 101 may be referred to as first light sources and the LEDs 106 disposed on the second substrate 102 may be referred to as second light sources.

Specifically, the LEDs 106 are disposed at regular intervals on the first substrate 101 and the second substrate 102 so that bright spots are not generated by the concentration of light. Further, the light from the LEDs 106 may be efficiently used by reflecting the light in the upper side of the reflection sheet 140.

The first auxiliary power supply unit 105A is positioned on the first substrate 101 and the second auxiliary power supply unit 105B is positioned on the second substrate 102. The first auxiliary power supply unit 105A receives voltage and signals from the power supply unit 40 via connector 46A, wires 47 and connector 46B and outputs drive voltages to LEDs 106 located on the first substrate 101 via wiring (not shown). The number of wires 47 may be considerably less than the number of wires connected between the first auxiliary power supply unit 105A and the LEDS 106.

Likewise, the second auxiliary power supply unit 105B receives voltage and signals from the power supply 40 via the first wires 171, the connection member 150 and the second wires 172, and outputs drive voltages to the LEDs 106 on the second substrate 102 via wires not shown. Again the number of first wires 171 and second wires 172 carrying voltage and signals to the second auxiliary power supply unit 105B is considerably less than the number of wires carrying drive voltage from the second auxiliary power supply unit 105B to the LEDs 106.

Specifically, a large number of LEDs 106 may be disposed at the first substrate 101 and the second substrate 102, and in the absence of the auxiliary power supply units 105A and 105B, a large number of wires would be required between the power-supply unit 40 and the first substrate 101 and between the power supply unit 40 and the second substrate 102 so as to supply drive voltage that is appropriate to the LEDs 106. Here, as the auxiliary power supply units 105A and 105B are mounted on the first substrate 101 and the second substrate 102 respectively, the number of wires required to connect the power-supply unit 40 to the first substrate 101 and to the second substrate 102 can be reduced. The number of wires connecting the first substrate 101 and the second substrate 102 can be reduced.

The first auxiliary power supply unit 105A, located on the first substrate 101, is electrically connected to the power-supply unit 40, and receives from the power supply unit 40 voltage and signals to generate a drive voltage to drive the LEDs 106. The power supply unit 40 also supplies such voltage and signals to the second auxiliary power supply unit 105B via the second wires 172 formed at the second substrate 102 via the first wires 171 and the connection member 150.

If the second auxiliary power supply unit 105B shown in FIG. 3A is omitted, the voltage and signals from the power supply unit 40 may be applied to the auxiliary power-supply unit 105A, located on the first substrate 101, to generate a drive voltage to be applied to the LEDs 106 on both the first substrate 101 and the second substrate 102.

However, in order to reduce the number of wires connecting the first substrate 101 and the second substrate 102, the drive voltage to drive the LEDs 106 on the second substrate 102 is finally generated through the second auxiliary power-supply unit 105B on the second substrate 102.

As illustrated in FIG. 3B, the first wires 171 and the second wires 172, which transmit a voltage and signals from the power supply 40 to the second auxiliary power supply unit 105B, are formed, respectively, on the first substrate 101 and the second substrate 102. It is preferable that the first substrate 101 is a first printed circuit board and that the second substrate 102 is a second printed circuit board and that the first wires 171 and second wires 172 are formed on the printed circuit boards.

The connection member 150 connects the first wires 171 to the second wires 172, and includes a connector 151 and connection wires 155.

The connector 151 includes a male connector 152 connected to connection wires 155 and a female connector 153 connected to the second wires 172 on the second substrate 102. The male connector 152 is inserted into the female connector 153, thus electrically connecting the connection wires 155 to the second wires 172. The connection wires 155 are connected to the first wires 171 on the first substrate 101. The male connector 152 may include a fixed projection 161 that is coupled with a fixed groove 162 formed in the female connector 153 to prevent accidental separation of the male connector 152 from the female connector 153.

The male connector 152 and the female connector 153 can be formed in various shapes. Further, the connection member 150 can be configured with the positions of the male connector 152 and the female connector 153 reversed.

As shown in FIG. 3C, one end of the connection wires 155 is electrically connected to the male connector 152, and the other end is connected to the first wires 171. The connection wires 155 according to the first embodiment of the present invention may include a multiple of separate connection wires. Such connection wires 155 can be formed in various lengths, and the number of connection wires 155 can be changed depending on the number of wires required to carry voltage and signals from the power supply unit 40 to the auxiliary power supply unit 105B.

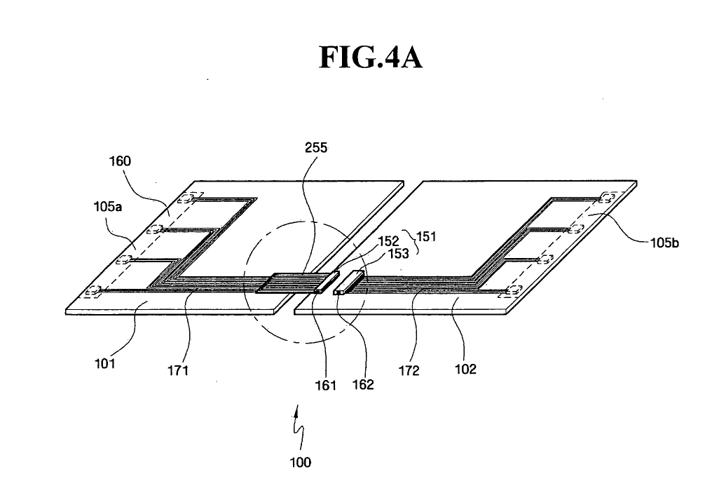

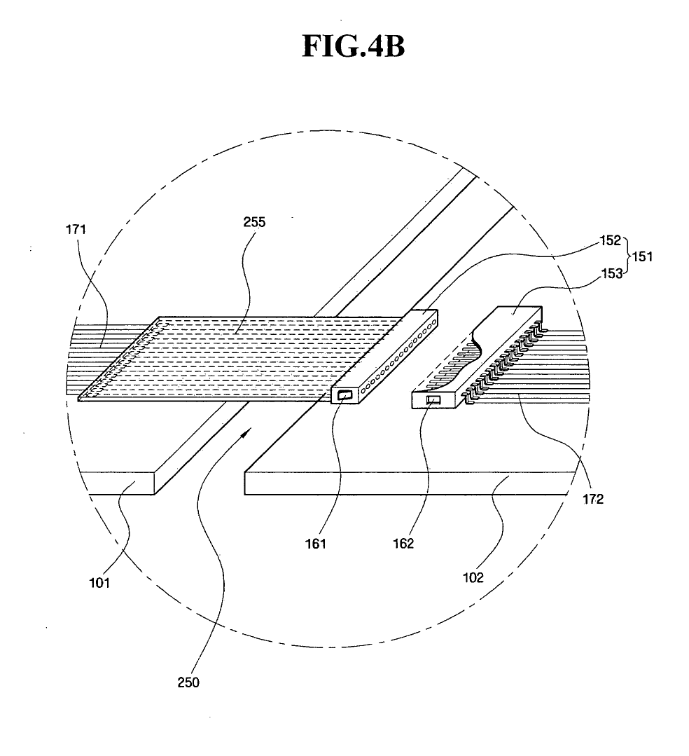

The backlight panel including a connection member according to a second embodiment of the present invention is described in detail with reference to FIGS. 4A and 4B. FIG. 4A is a perspective view of the lower side of a backlight panel 100 included in the LCD according to the second embodiment of the present invention, and FIG. 4B is a perspective view of a portion of the lower side of the backlight panel 100 of FIG. 4A.

The backlight panel 100, includes a first substrate 101, a second substrate 102, first wires 171 formed on the first substrate 101, second wires 172 formed on the second substrate 102, a first auxiliary power supply unit 105A disposed on the first substrate 101, a second auxiliary power supply unit 105B disposed on the second substrate, and a connection member 250.

As shown in FIG. 2, the power supply unit 40 is connected to the first substrate 101 via connectors 46A, wires 47 and connectors 46B.

The first auxiliary power supply unit 105A is connected to and receives voltage and signals from the power supply unit 40 via connectors 46B. The first auxiliary power supply unit 105A is also connected to and supplies a drive voltage to the light sources 106 on the first substrate 101 via first light source wiring (not shown).

The second auxiliary power supply unit 105B is connected to and receives voltage and signals from the power supply unit 40 via connectors 46B, the first wires 171, and the second wires 172 and the connection member 250. The second auxiliary power supply unit 105B is also connected to and supplies driving voltage to the light sources 106 on the second substrate 102 via second light source wiring (not shown).

The connection member 250 according to the second embodiment of the present invention includes a connector 151 connection wires 255 which are formed as a flexible printed circuit. The connector 151 is located on the second substrate 102 and includes a male connector 152 and a female connector 153. The female connector 153 is connected directly to the second wires 172. One end of the connection wires 255 is connected to the male connector 152 and the other end of the wires 255 is connected to the first wires 171. The male connector 152 includes a fixed projection 161 that engages with a fixed groove 162 in the female connector 153 for the purpose of preventing accidental separation of the male connector 152 from the female connector 153. Though the connector 151 is shown as being on the second substrate 102, it could alternatively be located on the first substrate 101 with the connection wires 255 connected between the connector 151 and the second wires 172. Likewise the relative positions of the male connecter 152 and the female connector 153 may be reversed.

The connection wires 255 include a plurality of wires formed as a flexible printed circuit and is connected to the male connector 152. In the case where the connection wiring 255 is formed as a flexible printed circuit, multiple wires can be simply connected.

Specifically, a multiple of LEDs 106 is arranged on the first substrate 101 and the second substrate 102, and a multiple of LEDs 106 can be connected by direct current. Likewise, in the case where a multiple of LEDs 106 are connected by direct current, a high voltage for driving the LED 106 is required. Hence, various drive voltages regulated as appropriate voltages, which can be used within the LCD 1, are necessary. That is, a separate drive voltage should be supplied for each LED 016 line. In the case Not shown in FIGS. 4A and 4B) where an auxiliary power-supply unit 105B is not included on the second substrate 102, the large number of wires required for supplying drive voltage from the auxiliary power supply 105A on the first substrate to the LED lines on the second substrate 102 are easily connected. Here, a large number of wires can be effectively connected using the connection wires 255 formed as a flexible printed circuit.

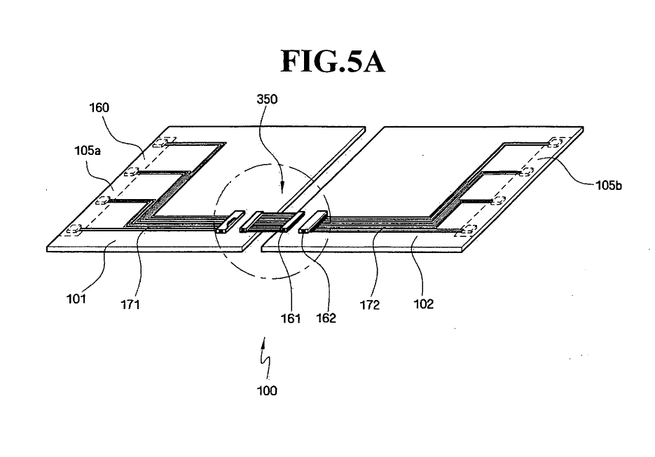

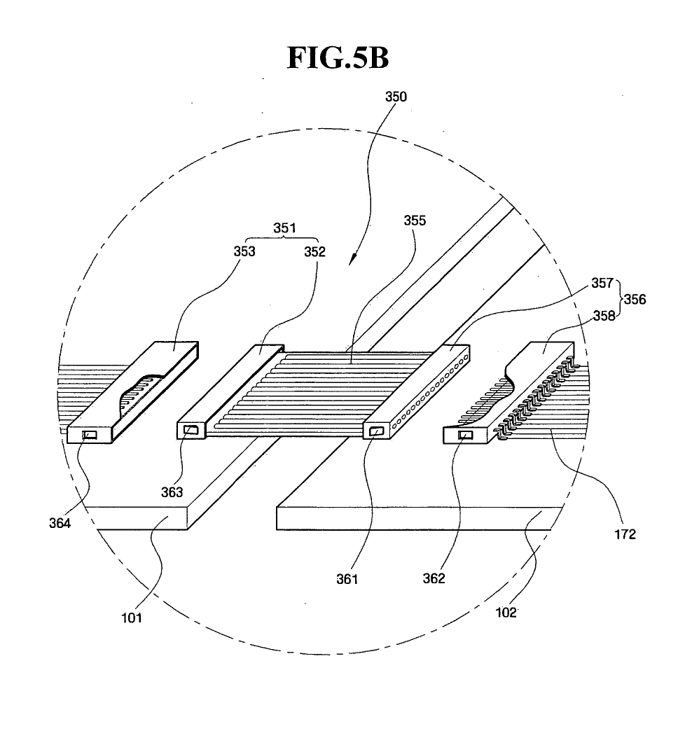

The backlight panel including the connection member according to a third embodiment of the present invention is described in detail with reference to FIGS. 5A and 5B. FIG. 5A is a perspective view of the lower side of the backlight panel 100 included in the LCD according to the third embodiment of the present invention, and FIG. 5B is a perspective view of a portion of the lower or underside of the backlight of FIG. 5A.

The backlight panel 100 according to the third embodiment of the present invention includes a connection member 350 wherein the connection member 350 includes a first connector 351, a second connector 356, and connection wires 355.

The first connector 351 includes a first male connector 352 and a first female connector 353, and the first female connector 353 is connected to the first wires 171 on the first substrate 101.

Further, the second connector 356 includes a second male connector 357 and a second female connector 358, and the second female connector 358 is connected to the second wires 172 on the second substrate 102.

Further, in the case of the connection wires 355, the first male connector 352 is connected to one end of the connection wires 355, and the second male connector 357 is connected to the other end of the connection wires 355.

In the connection member 350, the two connectors 351 and 356 are electrically connected through the connection wires 355, and the electrical connection and disconnection of the first substrate 101 and the second substrate 102 is made easy by using the connection wires 355 separated from the first substrate 101 and the second substrate 102, respectively.

Likewise, the first and second connectors 351 and 356 include coupling projections 363 and 361, respectively, and coupling grooves 364 and 362, respectively, and thus are not easily accidently separated.

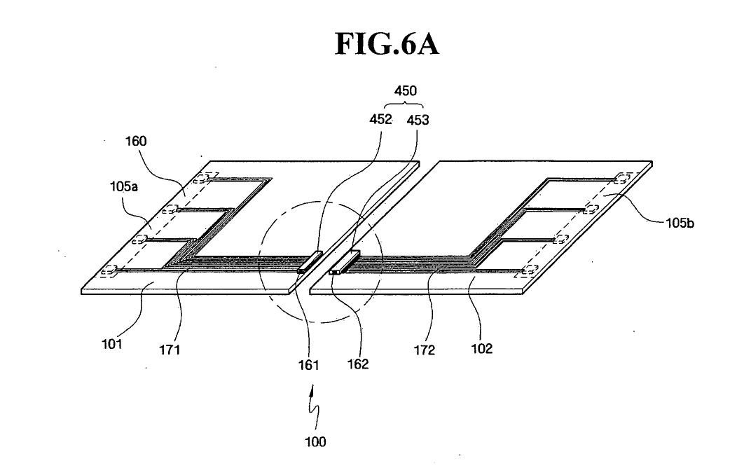

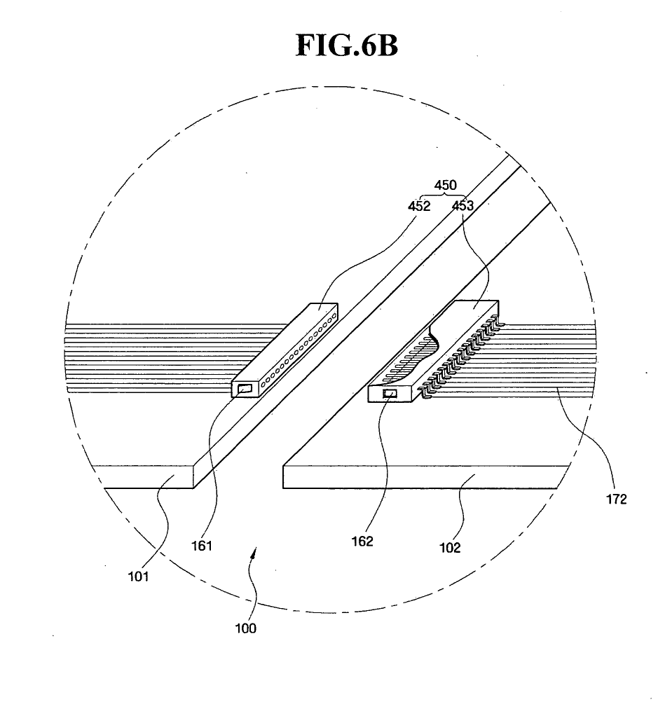

The backlight panel including the connection member according to a fourth embodiment of the present invention is described in detail with reference to FIGS. 6A and 6B. FIG. 6A is a perspective view of the lower side or underside of the backlight panel 100 included in the LCD according to the fourth embodiment of the present invention, and FIG. 6B is a perspective view of a portion of the lower side of the backlight panel of FIG. 6A.

The backlight panel 100 according to a fourth embodiment of the present invention includes the connection member 450 which includes a male connector 452 and a female connector 453 on the first substrate 101 and the second substrate 102, respectively, and directly couples the first substrate 101 and the second substrate 102.

The male connector 452 is disposed at the side of the first substrate 101 that is adjacent to the second substrate 102, and the female connector 453 is disposed at the side of the second substrate 102 that is adjacent to the first substrate 101. The male connector 452 is directly connected to the first wires 171, and the female connector 453 is directly connected to the second wires 172.

With the first substrate 101 and the second substrate 102 directly connected to the male connector 452 and the female connector 453, respectively, the physical coupling force between the male connector 452 and the female connector 453 tends to hold the first substrate 101 and the second substrate 102 in correct relation to each other. In the case where several connection members 450 are used, a separate fixing means may not be required to fix the first substrate 101 and the second substrate 102 in correct positions relative to each other.

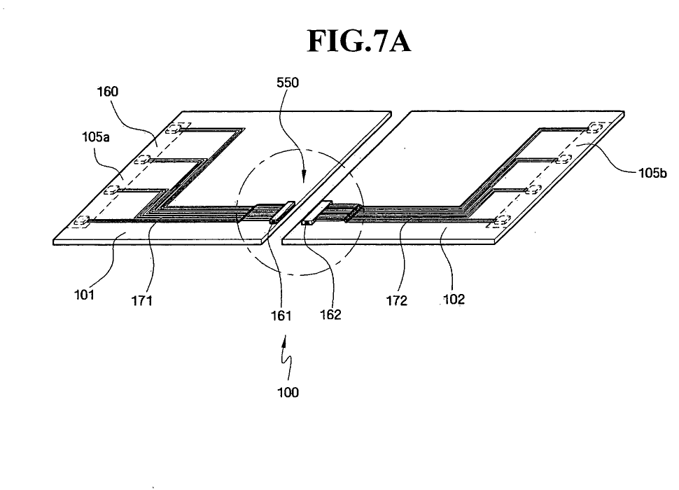

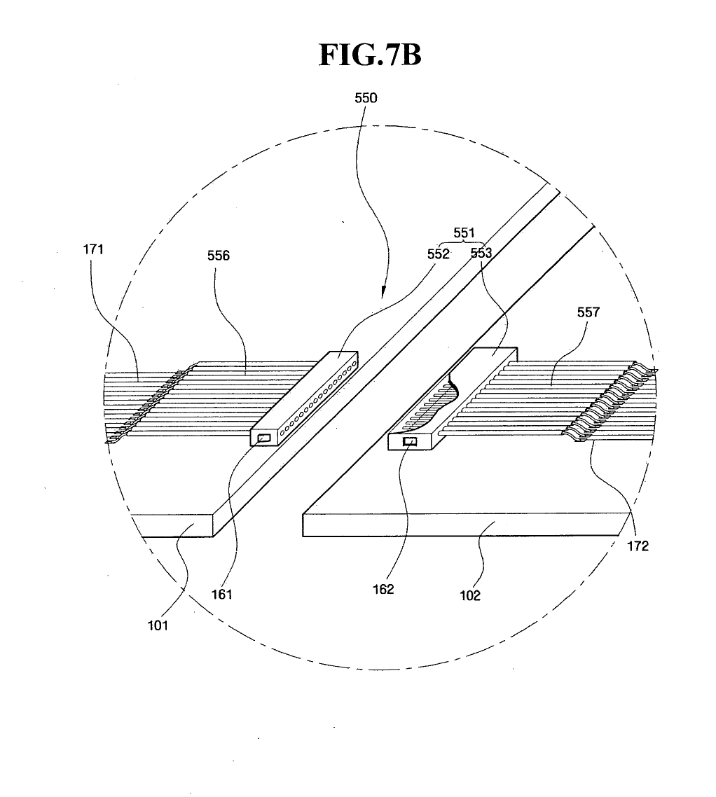

The backlight panel including a connection member according to a fifth embodiment of the present invention is described in detail with reference to FIGS. 7A and 7B. FIG. 7A is a perspective view of the lower side of the backlight panel included in the LCD according to the fifth embodiment of the present invention, and FIG. 7B is a perspective view of a portion of the lower side of the backlight panel of FIG. 7A.

The backlight panel 100 according to a fifth embodiment of the present invention includes a connection member 550 wherein the connection member 550 includes a connector 551, first connection wires 556 and second connection wires 557 and connects the connection wires 556 and the connection wires 557 to the connector 551.

The connector 551 includes a male connector 552 and a female connector 553. One end of the first connection wires 556 is connected to the first wires 171 on the first substrate 101, and the other end of the first connection wires 556 is connected to the male connector 552. Further, one end of the second connection wires 557 is connected to the second wires 172 on the second substrate 102, and the other end of the second connection wires 557 is connected to the female connector 553.

That is, the first connection wires 556 and the second connection wires 557 are electrically connected through the connector 551.

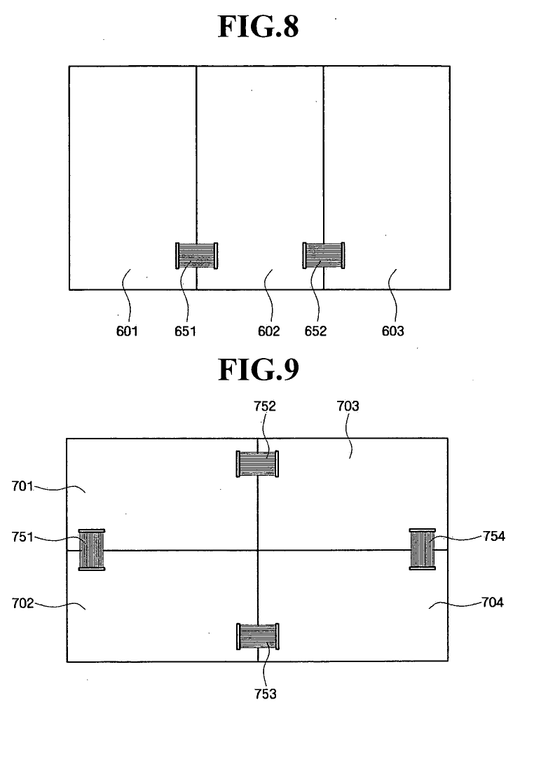

A modified arrangement of the backlight panel according to the present invention is described in detail with reference to FIGS. 8 and 9. FIGS. 8 and 9 are plan views illustrating the modified arrangement of the backlight panel.

The backlight panel according to the present invention can include three or more substrates. Referring to FIGS. 8, three substrates 601, 602 and 603 can be arranged in a row, and adjacent substrate can be connected by connection members 651 and 652. Referring to FIG. 9, four substrates 701, 702, 703 and 704 can be arranged in a rectangular array, and pairs of adjacent substrates can be connected by connection members 751, 752, 753 and 754. As shown in FIG. 9, the connection members 751, 752, 753, and 754 connect the pairs 701 and 702, 701 and 703, 702 and 704, and 703 and 704, respectively.

Here, an auxiliary power supply unit can be included on each of the substrates 601, 602, 603, 701, 702, 703 and 704 in order to reduce the number of wires to be connected to the connection members 651, 652, 751, 752, 753 and 754. Further, as the area of the backlight panel gets larger, if multiple substrates are used, a plurality of power-supply units may be provided.

It should be understood by those of ordinary skill in the art that various replacements, modifications and changes may be made in the form and details without departing from the spirit and scope of the present invention as defined by the following claims. Therefore, it is to be appreciated that the above described embodiments are for purposes of illustration only and the invention is not to be construed as limited to these embodiments.

According to an apparatus and method of the present invention, drive voltage can be supplied to light sources on a backlight panel including multiple substrates by using one power-supply unit, and by providing connection members so that the substrates can be easily connected, thereby reducing the manufacturing time and cost. To further simplify the wiring, the power supply unit may be assisted by auxiliary power supply units located on the substrates.

What is claimed is:

1. A backlight assembly comprising:
a first substrate;
a second substrate disposed adjacent to the first substrate;
one or more first light sources disposed on the first substrate;
one or more second light sources disposed on the second substrate; and
a power-supply unit that is electrically connected to the first substrate, the power supply unit supplying a drive voltage to the first light sources and the second light sources; wherein the drive voltage is applied to the first substrate, and is transmitted to the electrically connected second substrate through the first substrate.

2. The assembly of claim 1, further comprising a bottom receiving container disposed under the first substrate and under the second substrate; and a wire positioned between the light source and the bottom receiving container.

3. The assembly of claim 1, further comprising:
a first wire formed on the first substrate;
a second wire formed on the second substrate; and
a connection member that electrically connects the first substrate and the second substrate,
wherein the drive voltage is transmitted via the first wire, the connection member, and the second wire.

4. The assembly of claim 3, wherein the connection member includes a connector.

5. The assembly of claim 3, wherein the connection member includes a connector disposed on one of the first and second substrates, and connection wires connected to the other of the first and second substrates.

6. The assembly of claim 5, wherein the connection wires include one or more separate electric wires or a flexible printed circuit.

7. The assembly of claim 3, wherein the connection member includes:
first connection wires connected to the first wires;
second connection wires connected to the second wires; and
a connector that electrically connects the first connection wires to the second connection wires.

8. The assembly of claim 7, wherein the first connection wires and the second connection wires each include one or more separate electric wires or flexible printed circuits.

9. The assembly of claim 3, wherein the connection member includes:
a first connector connected to the first wires;
a second connector connected to the second wires; and
connection wires that electrically connects the first connector and the second connector.

10. The assembly of claim 9, wherein the connection wires includes one or more separate electrical wires or a flexible printed circuit.

11. The assembly of claim 3, wherein the first substrate and the second substrate are practically same.

12. The assembly of claim 3, wherein the first substrate is a first printed circuit board and the second substrate is a second printed circuit board.

13. The assembly of claim 12, wherein the pattern of the first wires and the pattern of the second wires are approximately the same.

14. The assembly of claim 1, wherein the first light sources and the second light sources are light-emitting diodes (LED).

15. The assembly of claim 1, further comprising a first auxiliary power supply unit disposed on the first substrate, the power supply unit being electrically connected to the auxiliary power supply unit and supplying voltage and signals to the first auxiliary power supply unit and the auxiliary power supply unit being electrically connected to the first light sources to supply a driving voltage to the first light sources.

16. The assembly of claim 1, further comprising a second auxiliary power supply unit disposed on the second substrate, the power supply unit being connected via the first wires and the second wires to the second auxiliary power supply unit to supply voltage and signals to the second auxiliary power supply unit, the second auxiliary power supply unit being electrically connected to the second light sources to supply a drive voltage to the second light sources.

17. The assembly of claim 1, further comprising:
a first auxiliary power supply unit disposed on the first substrate and electrically connected to the power supply unit and to the first light sources; and
a second auxiliary power supply unit disposed on the second substrate and electrically connected to the power supply unit and to the second light sources;
wherein the power supply unit supplies voltage and signals to the first and second auxiliary power supply units, the first auxiliary power supply unit supplies a driving voltage to the first light sources and the second auxiliary power supply unit supplies a driving voltage to the second light sources.

18. The assembly of claim 1, further comprising:
one or more additional substrates disposed adjacent to the first substrate or the second substrate, and one or more light sources disposed on the one or more additional substrates, respectively,
wherein the drive voltage is transmitted to the additional substrates via the first substrate or the second substrate.

19. The assembly of claim 2, wherein the bottom receiving container includes an opening formed so that the connection member is exposed.

20. The assembly of claim 19, wherein the opening is located on the boundary between the first substrate and the second substrate, and is located between the center of the bottom receiving container and an edge of the bottom receiving g container.

21. A liquid crystal device (LCD) comprising:
a liquid crystal panel that displays images; and
a backlight assembly that provides light to the liquid crystal panel,
wherein the backlight assembly includes a first substrate, a second substrate disposed adjacent to the first substrate, one or more light sources disposed on the first substrate and the second substrate, respectively, a power supply unit that is electrically connected to the first substrate, and applies a drive voltage to the light sources, and a bottom receiving container disposed on the lower side of the first substrate and the second substrate, and
wherein the drive voltage is applied to the first substrate, and is transmitted to the second substrate through the first substrate.
